(19) United States
(12) Patent Application Publication
(10) Pub. No.: US 2020/0342793 A1
(43) Pub. Date: Oct. 29, 2020

(54) ILLUMINATED DISPLAY PILLAR WITH LIGHT CHANNEL

(71) Applicant: MOGL LLC d.b.a. Luxbii, Dallas, TX (US)

(72) Inventors: Lee Michael Patterson, Dallas, TX (US); Carolyn Louise Querbes, Dallas, TX (US)

(21) Appl. No.: 16/863,132

(22) Filed: Apr. 30, 2020

Related U.S. Application Data
(63) Continuation-in-part of application No. 16/367,983, filed on Mar. 28, 2019, now Pat. No. 10,643,509.

(51) Int. Cl. G09F 13/04; G09F 13/08; G09F 13/22

(52) U.S. Cl. CPC G09F 13/0413; G09F 13/08; G09F 13/22; G09F 2013/0431; G09F 2013/0481; G09F 2013/0445; G09F 2013/222

(57) ABSTRACT

An illuminated display pillar, including a post, a flexible membrane positioned within the post and adjacent to the window, the flexible membrane including a transparent portion; a light transmissive cylindrical housing positioned at the first opening, the cylindrical housing including a top portion and a curved portion extending about a circumference of the cylindrical housing; a shade positioned on the curved portion of the cylindrical housing; and a light channel extending at least partially between the first and the second ends of the post, the light channel providing illumination through the window and the light transmissive cylindrical housing, wherein the shade separates the illumination through the top portion of the cylindrical housing from the illumination through the curved portion of the cylindrical housing.

### CROSS-REFERENCE TO RELATED APPLICATION(S)

This application is a continuation-in-part of and claims the benefit of U.S. patent application Ser. No. 16/367,983 filed on Mar. 28, 2019, the disclosure of which is expressly incorporated herein by reference in its entirety.

### BACKGROUND

### Field of the Disclosure

The disclosure relates generally to display pillars, including illuminated display pillars with a light channel providing the illumination.

### Description of the Related Art

Illuminated display devices for displaying information and, in particular for displaying advertising material, are often effective. One typical form of illuminated displays is a back lit display in which a translucent or transparent display surface is back illuminated by a light and display material in sheet form, such as an advertising poster, that is attached to the inside of the display surface. Such back lit illuminated displays are commonly used for display and advertising purposes.

### SUMMARY

Innovative aspects of the subject matter described in this specification may be embodied in an illuminated display pillar, comprising a post, comprising i) a lower portion and an upper portion, the lower portion and the upper portion substantially opaque; ii) a middle portion positioned between the lower and upper portions, the middle portion including a window extending around at least a portion of a circumference of the post; iii) a first opening positioned at a first end of the post and a second opening positioned at a second, opposing end of the post; a flexible membrane positioned within the post and adjacent to the window, the flexible membrane including a transparent portion; a light transmissive cylindrical housing positioned at the first opening, the cylindrical housing including a top portion and a curved portion extending about a circumference of the cylindrical housing; a shade positioned on the curved portion of the cylindrical housing; and a light channel extending at least partially between the first and the second ends of the post, the light channel providing illumination through the window and the light transmissive cylindrical housing, wherein the shade separates the illumination through the top portion of the cylindrical housing from the illumination through the curved portion of the cylindrical housing.

These and other embodiments may each optionally include one or more of the following features. For instance, the light channel includes i) a light transmissive cylindrical post and ii) a light source positioned within the light transmissive cylindrical post. The light source is a light-emitting diode (LED) strip positioned within the light transmissive cylindrical post. The light channel is coupled to the upper portion of the post. Further comprising a rod positioned through at least a part of the upper portion of the post and through the light channel to couple the light channel to the upper portion of the post. Further comprising at least two flush bars positioned in an interior volume of the post and extending at least a portion of a length of the post and are adjacent to the window such that the flexible membrane is positioned between the flush bars and the post. The shade includes an opening, the opening of the shade overlaying the top portion of the cylindrical housing. The opening of the shade is flush with the top portion of the cylindrical housing. The shade includes a flange, the flange extending past the circumference of the post. A portion of the middle portion is substantially opaque, the portion of the middle portion opposite to the flexible membrane. Further comprising a stake coupled to the post adjacent to the second opening of the post. Further comprising a photovoltaic cell coupled to the light channel to provide the illumination. The photovoltaic cell is positioned along an outer diameter of the post at the second end of the post.

Innovative aspects of the subject matter described in this specification may be embodied in an illuminated display pillar, comprising a cylindrical post, comprising i) a lower portion and an upper portion, the lower portion and the upper portion substantially opaque; ii) a middle portion positioned between the lower and upper portions, the middle portion including a window extending around a portion of a circumference of the cylindrical post; iii) a first opening positioned at a first end of the cylindrical post and a second opening positioned at a second, opposing end of the cylindrical post; a flexible membrane positioned within the cylindrical post and adjacent to the window, the flexible membrane including a transparent portion; a light transmissive cylindrical housing positioned at the first opening, the cylindrical housing including a top portion and a curved portion extending about the circumference of the cylindrical housing; a shade positioned on the curved portion of the cylindrical housing; and a light channel extending at least partially between the first and the second ends of the post, the light channel providing illumination through the window and the curved portion of the light transmissive cylindrical housing.

These and other embodiments may each optionally include one or more of the following features. For instance, the light channel includes i) a light transmissive cylindrical post and ii) a light source positioned within the light transmissive cylindrical post. The light source is a light-emitting diode (LED) strip positioned within the light transmissive cylindrical post. The light channel is coupled to the upper portion of the post. Further comprising a rod positioned through at least a part of the upper portion of the post and through the light channel to couple the light channel to the upper portion of the post. Further comprising at least two flush bars positioned in an interior volume of the post and extending at least a portion of a length of the post and are adjacent to the window such that the flexible membrane is positioned between the flush bars and the post.

Innovative aspects of the subject matter described in this specification may be embodied in an illuminated display pillar, comprising a post, comprising i) a lower portion and an upper portion, the lower portion and the upper portion substantially opaque; ii) a middle portion positioned between the lower and upper portions, the middle portion including a window extending around at least a portion of a circumference of the post; iii) a first opening positioned at a first end of the post and a second opening positioned at a second, opposing end of the post; a flexible membrane positioned within the post and adjacent to the window, the flexible membrane including a transparent portion; flush bars extending between the first and the second ends of the post and coupled to the lower portion and the upper portions of the post, the flush bars positioned adjunct to the first opening such that the flexible membrane is positioned between the flush bars and the post; a light transmissive cylindrical housing positioned at the first opening, the cylindrical housing including a top portion and a curved portion extending about a circumference of the cylindrical housing; a shade positioned on the curved portion of the cylindrical housing; and a light channel extending at least partially between the first and the second ends of the post and coupled to the upper portion of the post, the light channel including i) a light transmissive cylindrical post and ii) a light source positioned within the light transmissive cylindrical post, the light channel providing illumination through the window and the light transmissive cylindrical housing, wherein the shade separates the illumination through the top portion of the cylindrical housing from the illumination through the curved portion of the cylindrical housing.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 illustrates a side view of an illuminated display pillar.

FIG. 2 illustrates a top-down view of the illuminated display pillar.

FIG. 3 illustrates a perspective view of the illuminated display pillar.

FIG. 4 illustrates a side view of the illuminated display pillar, including a holographic fan.

FIG. 5 illustrates a side view of the illuminated display pillar, including a light channel.

FIG. 6A illustrates a top down perspective view of the illuminated display pillar, including the light channel.

FIG. 6B illustrates a side cut-away view of the illuminated display pillar, including the light channel.

FIG. 7 illustrates a perspective view of the illuminated display pillar, including flush bars.

FIG. 8 illustrates a side view of the illuminated display pillar, including a stake.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

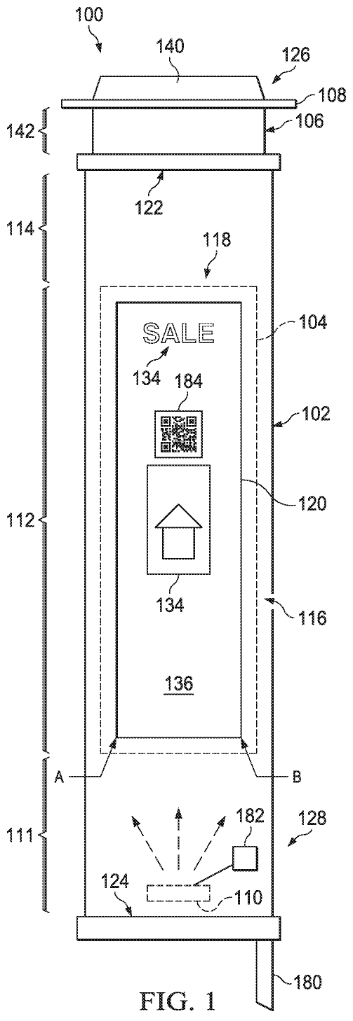

FIG. 1 illustrates an illuminated display pillar 100. The display pillar 100 can include a cylindrical post 102, a flexible membrane 104, a light transmissive cylindrical housing 106, a shade 108, and a light source 110. The cylindrical post 102 can include a lower portion 111, a middle portion 112, and an upper portion 114. In some examples, the post 102 can include other geometric shapes (cross-sectional views) such as a square-based shape, a rectangular-based shape, or any geometric shape desired. The lower portion 111 and the upper portion 114 can be substantially opaque. The middle portion 112, positioned between the lower portion 111 and the upper portion 114, can include a first sub-portion 116 and a second sub-portion 118.

The first sub-portion 116 of the middle portion 112 can be substantially opaque. The second sub-portion 118 of the middle portion 112 can include a window 120 that extends around a circumference of the cylindrical post 102. The window 120 can extend around the circumference of the cylindrical post 102 any desired amount—in the illustrated example, the window 120 extends between points A and B (approximately one-half of the circumference of the cylindrical post 102). However, in some examples, the window 120 can extend around the circumference of the cylindrical post 102 greater than the circumferential distance between points A and B, or less than the circumferential distance between points A and B.

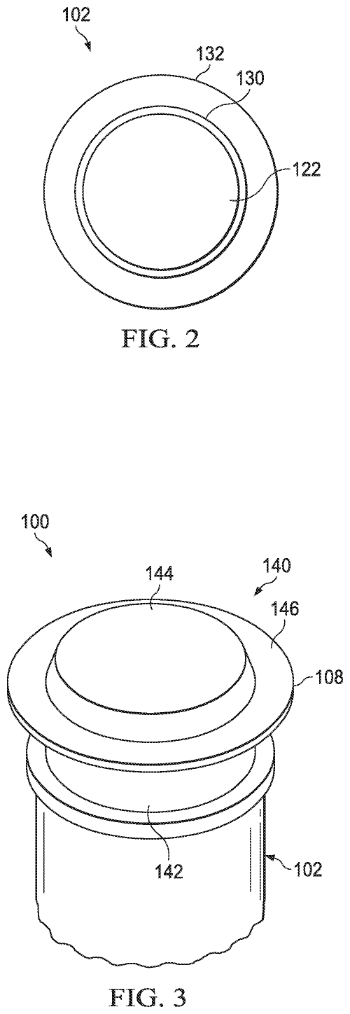

The cylindrical post 102 further includes a first opening 122 and a second opening 124. The first opening 122 can be positioned at a first end 126 of the cylindrical post 102 and the second opening 124 can be positioned at a second end 128 of the cylindrical post 102. The first end 126 and the second end 128 can be at opposite ends of the cylindrical post 102. In some embodiments, the cylindrical post 102 is hollow—that is, the cylindrical post 102 includes an inner diameter 130 and an outer diameter 132, as shown in FIG. 2.

The flexible membrane 104 can be positioned within the cylindrical post 102 and adjacent to the window 120. In some examples, the flexible membrane 104 is positioned within the cylindrical post 102 opposite to the first sub-portion 116 of the middle portion 112. That is, the flexible membrane 104 can be positioned to be in contact with the inner diameter 130 of the cylindrical post 102. The flexible membrane 104 can include transparent portions 134 and opaque portions 136. In some examples, the flexible membrane 104 can further include translucent portions (not shown). In some examples, the flexible membrane 104 comprises a material (e.g., semi-rigid material or rigid material) such that the flexible membrane 104 exerts a force against the inner diameter 130 of the cylindrical post 102 to maintain a desired positioning of the flexible membrane 104 with respect to the window 120. Specifically, the flexible membrane 104 exerts a force against the cylindrical post 102 at portions adjacent to the window 120 and about the inner diameter 130. In some examples, the flexible membrane 104 can be positioned within the cylindrical post 102 and adjacent to the window 120 by other means such brackets, screws, and other coupling methods.

In some examples, the flexible membrane 104 can include a static image on the semi-rigid or rigid material (e.g., a plastic-based) substrate. In some examples, the flexible membrane 104 can include a flexible, digital screen—e.g., a light emitting diode (LED) screen or an organic LED (OLED) screen. The digital screen can provide a static image, a moving image, or a video.

The light transmissive cylindrical housing 106 can be positioned at the first opening 122 of the cylindrical post 102. That is, the cylindrical housing 106 can be coupled to the cylindrical post 102 at the first opening 122. The cylindrical housing 106 can be fixedly attached to the cylindrical post 102 such as by fasteners, or adhesive. In some examples, the cylindrical housing 106 can be removably attached to the cylindrical post 102.

The cylindrical housing 106 can include a top portion 140 and a curved portion 142 that extends about the circumference of the cylindrical housing 106. Each of the top portion 140 and the curved portion 142 can be substantially light transmissive, or a portion of the top portion 140 and the curved portion 142 are light transmissive. A circumference of the cylindrical housing 106 can be substantially the same as the circumference of the cylindrical post 102. However, in some examples, the circumference of the cylindrical housing 106 can be larger or smaller than the circumference of the cylindrical post 102. In some examples, the circumference of the cylindrical housing 106 can be substantially the same as the inner diameter 130 of the cylindrical post 102.

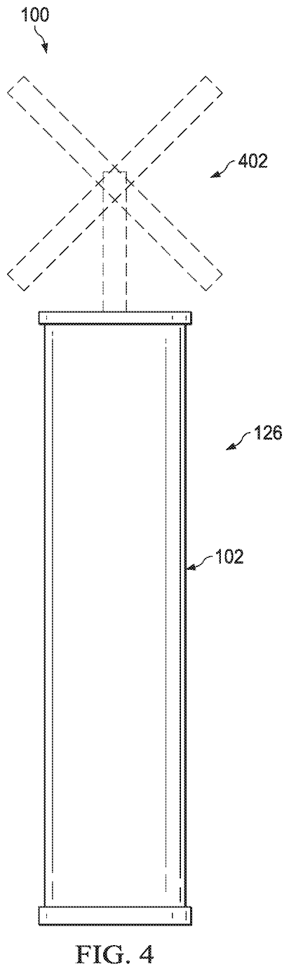

Referring to FIGS. 1 and 3, the shade 108 can be positioned on the curved portion 142 of the cylindrical housing 106. The shade 108 can include an opening 144 and a flange 146. The opening 144 can overlay the top portion 140 of the cylindrical housing 106, and can be flush with the top portion 140 of the cylindrical housing 106. The shade 108 can include a circumference that is substantially the same as the circumference of the cylindrical post 102. In some examples, the flange 146 can further extend past the circumference of the cylindrical post 102.

The light source 110 is positioned at the second opening 124 of the cylindrical post 102. The light source 110 can be fixedly attached to the cylindrical post 102—e.g., by screws, fasteners, or other means. In some examples, the light source 110 is removably attached to the cylindrical post 102. The light source 110 can include a mechanism that provides illumination, including LED or solar-based lights. To that end, the light source 110 provides illumination through the window 120 and the cylindrical housing 106. That is, the light source 110 directs illumination from the second opening 124 towards the first opening 122, and further, through the window 120 and the cylindrical housing 106.

The shade 108 can separate the illumination that is provided through the cylindrical housing 106. That is, the shade 108 can separate the illumination through the top portion 140 of the cylindrical housing 106 from the illumination through the curved portion 142 of the cylindrical housing 106. Separation of the illumination through the top portion 140 of the cylindrical housing 106 from the illumination through the curved portion 142 of the cylindrical housing 106 can facilitate having a distinct and a separate visual appearance of the illumination though the cylindrical housing 106. That is, two separate illuminations are provided through the cylindrical housing 106—through the top portion 140 and the curved portion 142—from the light source 110.

In some examples, the shade 108 includes a cover (not shown) that is in superimposition with the top portion 140 of the cylindrical housing 106. The cover can include a photovoltaic cell that is coupled to the light source 110 to provide the illumination through the illuminated display pillar 100. The light source 110 provides illumination through the window 120 and the cylindrical housing 106. That is, the light source 110 directs illumination from the second opening 124 towards the first opening 122, and further, through the window 120 and the curved portion 142 of the cylindrical housing 106. In some examples, the cover is removable.

In some examples, the display pillar 100 includes a light transmissive spherical housing (not shown) in lieu of the cylindrical housing 106. The spherical housing can be coupled to the cylindrical post 102 at the first opening 122. The spherical housing can be fixedly attached to the cylindrical post 102 such as by fasteners, or adhesive. The spherical housing can be removably attached to the cylindrical post 102. A circumference of the spherical housing can be substantially the same as the circumference of the cylindrical post 102. However, in some examples, the circumference of the spherical housing can be larger or smaller than the circumference of the cylindrical post 102. To that end, the light source 110 provides illumination through the window 120 and the spherical housing. That is, the light source 110 directs illumination from the second opening 124 towards the first opening 122, and further, through the window 120 and the spherical housing.

The illuminated display pillar 100 can further include a stake 180 that is coupled to cylindrical post 102 adjacent to the second opening 124 of the cylindrical post 102. The stake 180 can have a shape such that the same can be positioned within a substrate—e.g., a natural ground—by positioning the stake within the substrate. Thus, the illuminated display pillar 100 can be positioned within the same substrate. The stake 180 can further include, or be coupled to, a locking mechanism such that the stake, and the illuminated display pillar 100, cannot be removed from the substrate once inserted without a proper unlocking mechanism.

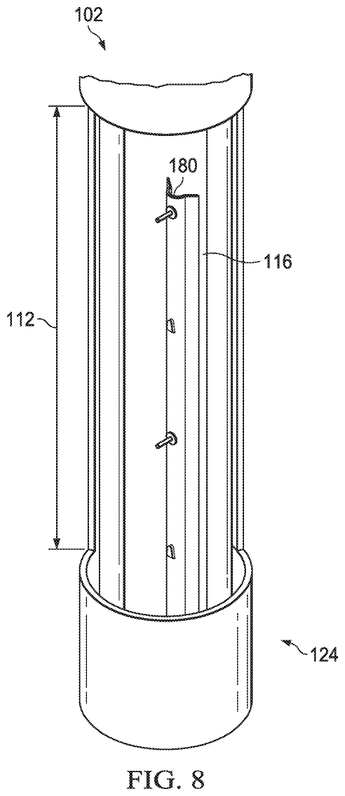

Referring to FIG. 8, in some examples, the stake 180 can extend along the cylindrical post 102 from the second opening 124 to the first sub-portion 116 of the middle portion 112. The stake 180 can be fixedly attached to the cylindrical post 102—e.g., by screws, fasteners, or other means. In some examples, a length of the stake 180 can be at least half a length of the cylindrical post 102 (between the first end 126 and the second end 128). The length of the stake 180 can provide stability to the cylindrical post 102 when the stake 180 is positioned with the substrate—e.g., by minimizing and/or preventing movement, pitching, or angulation of the cylindrical post 102 from a desired (e.g., vertical) position.

The illuminated display pillar 100 can further comprise a photovoltaic cell (solar cell) 182 that is coupled to the light source 110 to provide the illumination. That is, the light source 110 can be in electrical communication with the photovoltaic cell 182 to obtain energy (power) from the photovoltaic cell 182 to provide the illumination by the light source 110. In some examples, the light source 110 can further be connected to electrical power via an electrical grid—in place of, or in coordination with—receiving electrical power from the photovoltaic cell 182. In some examples, the photovoltaic cell 182 is coupled to the lower portion 111 of the cylindrical post 102. In some examples, the solar cell 182 can be a flexible solar cell. As such, the solar cell 182 can be positioned along the outer diameter 132 of the cylindrical post 102. For example, the solar cell 182 can be positioned along the outer diameter 132 at the second end 128 of the cylindrical post 102.

In some examples, the flexible membrane 104 includes an advertisement or other informational, promotional, or similar content. In a use-case example, the illuminated display pillar 100 can be positioned adjacent a physical property associated with a real estate listing. The illuminated display pillar 100, and in particular, the flexible membrane 104, can display information associated with the real estate listing. For example, the flexible membrane 104 can list information regarding particulars of the physical property, and contact information associated with the real estate listing. In a further use-case example, the illuminated display pillar 100 can be positioned adjacent an event space that is hosting an event. The illuminated display pillar 100, and in particular, the flexible membrane 104, can display information associated with the event, such as a time of the event and speakers at the event.

In some examples, the flexible membrane 104 includes a quick response (QR) code 184. The QR code 184 can be scanned and processed by a computing system—e.g., a mobile computing device or tablet computing device—to provide detail regarding information associated with the illuminated display pillar 100 and/or the flexible membrane 104 that is presented for display by the computing system.

In some examples, the illuminated display pillar 100 can further include an augmented reality (AR), a mixed reality (MR) and/or virtual reality (VR) system (not shown). The AR/MR/VR system can be positioned within the cylindrical post 102 and provide for display AR, MR, and/or VR images—e.g., images associated with information contained by the flexible membrane 104 and/or the display pillar 100. In some examples, the illuminated display pillar 100 includes a holographic system. The holographic system can be positioned within the cylindrical post 102 and provide holographic images—e.g., images associated with information contained by the flexible membrane and/or the display pillar 100.

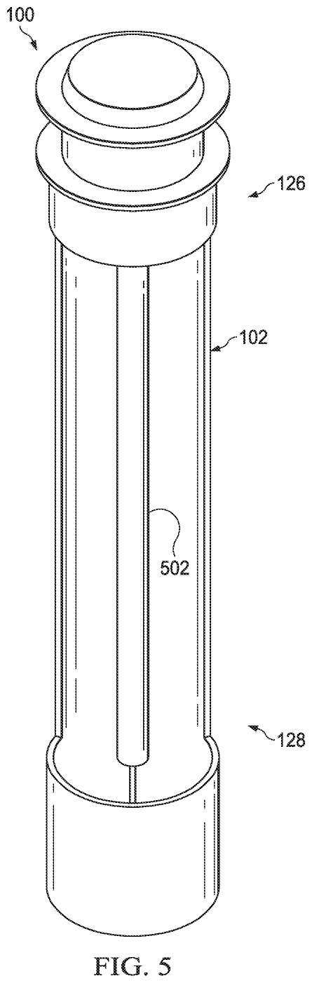

Referring to FIG. 4, in some examples, the holographic system can include a holographic fan 402 positioned at the first end 126 of the cylindrical post 102. The holographic fan 402 can be coupled to a tripod (not shown) positioned within the display pillar 100, and including one or more legs to support the holographic fan 402. In some examples, the holographic fan 402 can be utilized in lieu of the light transmissive cylindrical housing 106, or in combination with the light transmissive cylindrical housing 106.

In some examples, the illuminated display pillar 100 can further proximity detection systems such as Bluetooth, Geofencing and/or near field communications (NFC). The proximity detection systems can detect when a computing system—e.g., a mobile computing device or tablet computing device—is proximate to the display pillar 100. This proximity detection can facilitate identification of the display pillar 100 by the computing system—e.g., in coordination with the computing system scanning the QR code of the display pillar 100.

In some examples, the illuminated display pillar 100 can further include an audio system (not shown). The audio system can provide audio that is associated with the information that is contained by the flexible membrane 104 and/or the display pillar 100.

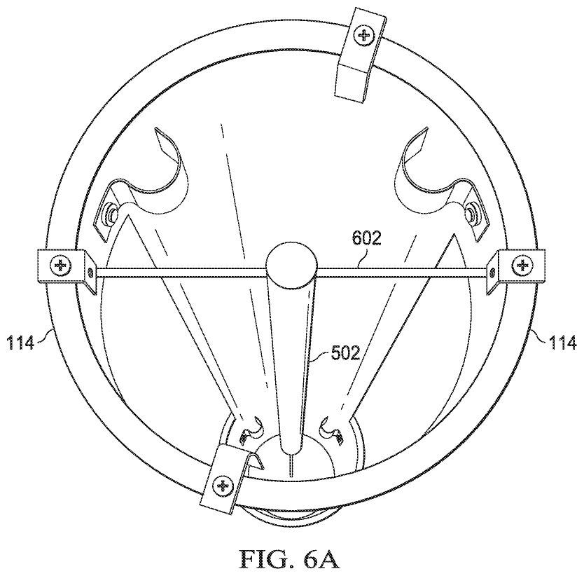

Referring to FIG. 5, in some examples, the display pillar 100 can include a light channel 502. The light channel 502 can extend at least partially between the first end 126 of the cylindrical post 102 and the second end 128 of the cylindrical post 102 and be positioned within the cylindrical post 102. The light channel 502 can be fixedly attached to the cylindrical post 102—e.g., by screws, fasteners, or other means.

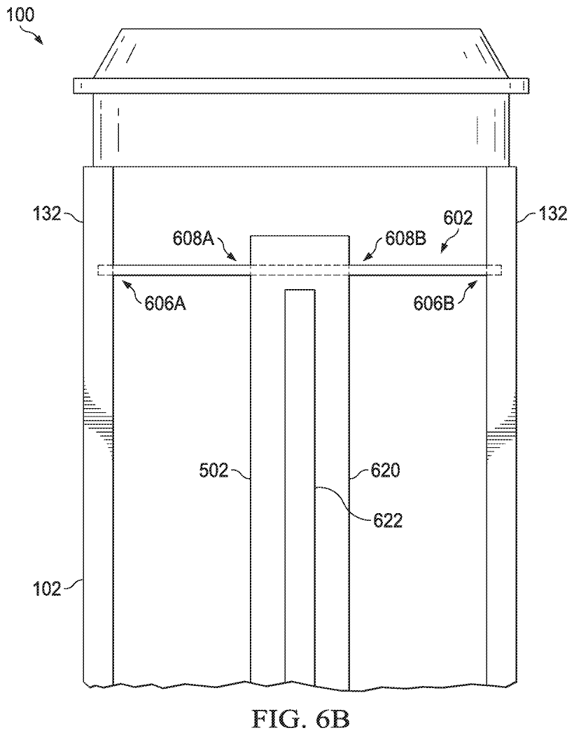

Referring to FIGS. 6A and 6B, in some examples, the light channel 502 is coupled to the upper portion 114 of the cylindrical post 102. Specifically, the display pillar 100 can include a rod 602 positioned i) through at least a part of the upper portion 114 of the cylindrical post 102 and ii) through the light channel 502. In some examples, the rod 602 can be a single contiguous body that is positioned within corresponding i) through holes 606a, 606b, of the upper portion 114 of the cylindrical post 102 and ii) through holes 608a, 608b of the light channel 502. In some examples, the rod 602 is positioned within the cylindrical post 102 at the upper portion 114 such that the rod is encapsulated by the cylindrical post 102. That is, the rod 602 does not extend past the outer diameter 132 of the cylindrical post 102 into an environment containing the display pillar 100.

When the rod 602 is positioned through at least a part of the upper portion 114 of the cylindrical post 102 and ii) through the light channel 502, the light channel 502 is coupled to the upper portion 114 of the cylindrical post 102. In some examples, the light channel 502 can additionally be coupled to the lower portion 111 of the cylindrical post 102. That is, similar to the rod 602, the display pillar 100 can include an additional rod positioned i) through at least a part of the lower portion 111 of the cylindrical post 102 and ii) through the light channel 502.

In some examples, the light channel 502 is removably attached to the cylindrical post 102.

In some examples, the light channel 502 extends at least the length of the window 120.

The light channel 502 can include a light transmissive cylindrical post 620 and a light source 622 positioned within the light transmissive cylindrical post 620. In some examples, the light source 622 is a light-emitting diode (LED) strip or LED tape positioned within the light transmissive cylindrical post 620. The light source 622 can be fixedly attached to the light transmissive cylindrical post 620—e.g., by screws, fasteners, adhesive, or other means. In some examples, the light source 622 is removably attached to the light transmissive cylindrical post 620. The light source 622 provides illumination through the light transmissive cylindrical post 620. Further, the light channel 502, and ultimately, the light source 622, provides illumination through the window 120 and the cylindrical housing 106. Specifically, similar to that mentioned above with respect to the light source 110, the light channel 502, and ultimately the light source 622, can provide illumination through the cylindrical housing 106—i.e., through the top portion 140 and the curved portion 142 of the cylindrical housing 106.

In some examples, the photovoltaic cell 182 can be coupled to the light channel 502, and specifically, coupled to the light source 622 to provide the illumination.

In some examples, the display pillar 100 can include the light channel 502 in combination with the light source 110. In some examples, the display pillar 100 includes the light channel 502 in lieu of the light source 110.

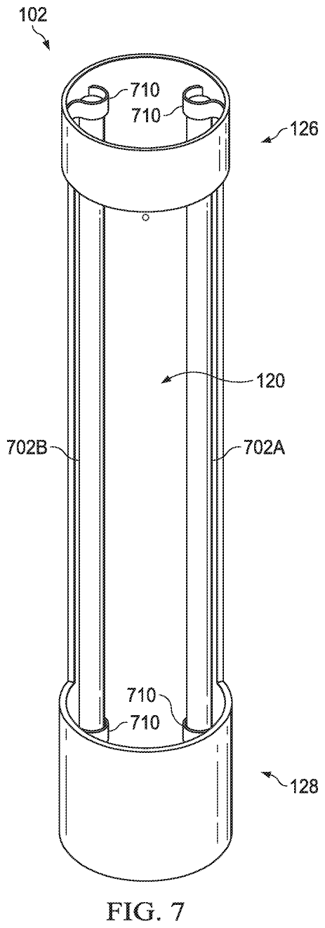

Referring to FIG. 7, in some implementations, the display pillar 100 can include flush bars 702a, 702b (collectively referred to as flush bars 702). The flush bars 702 are positioned within an interior volume of the cylindrical post 102 and extend at least a portion of a length of the cylindrical post 102. Specifically, the flush bars 702 extend between the first end 126 of the cylindrical post 102 and the second end 128 of the cylindrical post 102. The flush bars 702 are coupled to the lower portion 111 and the upper portion 114 of the cylindrical post 102. For example, the flush bars 702 are coupled to the cylindrical post 102 using brackets 710. In some examples, the flush bars 702 are positioned adjacent to the window 120 along the length of the cylindrical post 102 between the first end 126 of the cylindrical post and the second end 128 of the cylindrical post 102.

The flush bars 702 facilitate maintaining a desired positioning of the flexible membrane 104 with respect to the window 120. Specifically, the flexible membrane 104 can be positioned between the flush bars 702 and the cylindrical post 102. That is, the flush bars 702 facilitate positioning the flexible membrane 104 “flush” against the interior diameter 130 of the cylindrical post 102. In some examples, the flush bars 702 can exert a force against the flexible membrane 104 to maintain the desired positioning of the flexible membrane 104 with respect to the window 120, e.g., the flush bars 702 exert the force against the flexible membrane 104 at portions adjacent to the window 120 and in between the flush bars 702 and the cylindrical post 102.

In some examples, a length of the flush bars 702 is greater than a length of the flexible membrane 104 along the first end 126 of the cylindrical post 102 and the second end 128 of the cylindrical post 102.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An illuminated display pillar, comprising:
a post, comprising:
i) a lower portion and an upper portion, the lower portion and the upper portion substantially opaque;
ii) a middle portion positioned between the lower and upper portions, the middle portion including a window extending around at least a portion of a circumference of the post;
iii) a first opening positioned at a first end of the post and a second opening positioned at a second, opposing end of the post;
a flexible membrane positioned within the post and adjacent to the window, the flexible membrane including a transparent portion;
a light transmissive cylindrical housing positioned at the first opening, the cylindrical housing including a top portion and a curved portion extending about a circumference of the cylindrical housing;
a shade positioned on the curved portion of the cylindrical housing; and
a light channel extending at least partially between the first and the second ends of the post, the light channel providing illumination through the window and the light transmissive cylindrical housing, wherein the shade separates the illumination through the top portion of the cylindrical housing from the illumination through the curved portion of the cylindrical housing.

2. The illuminated display pillar of claim 1, wherein the light channel includes i) a light transmissive cylindrical post and ii) a light source positioned within the light transmissive cylindrical post.

3. The illuminated display pillar of claim 2, wherein the light source is a light-emitting diode (LED) strip positioned within the light transmissive cylindrical post.

4. The illuminated display pillar of claim 1, wherein the light channel is coupled to the upper portion of the post.

5. The illuminated display pillar of claim 4, further comprising a rod positioned through at least a part of the upper portion of the post and through the light channel to couple the light channel to the upper portion of the post.

6. The illuminated display pillar of claim 1, further comprising at least two flush bars positioned in an interior volume of the post and extending at least a portion of a length of the post and are adjacent to the window such that the flexible membrane is positioned between the flush bars and the post.

7. The illuminated display pillar of claim 1, wherein the shade includes an opening, the opening of the shade overlaying the top portion of the cylindrical housing.

8. The illuminated display pillar of claim 2, wherein the opening of the shade is flush with the top portion of the cylindrical housing.

9. The illuminated display pillar of claim 1, wherein the shade includes a flange, the flange extending past the circumference of the post.

10. The illuminated display pillar of claim 1, wherein a portion of the middle portion is substantially opaque, the portion of the middle portion opposite to the flexible membrane.

11. The illuminated display pillar of claim 1, further comprising a stake coupled to the post adjacent to the second opening of the post.

12. The illuminated display pillar of claim 1, further comprising a photovoltaic cell coupled to the light channel to provide the illumination.

13. The illuminated display pillar of claim 12, wherein the photovoltaic cell is positioned along an outer diameter of the post at the second end of the post.

14. An illuminated display pillar, comprising:
a cylindrical post, comprising:
i) a lower portion and an upper portion, the lower portion and the upper portion substantially opaque;
ii) a middle portion positioned between the lower and upper portions, the middle portion including a window extending around a portion of a circumference of the cylindrical post;
iii) a first opening positioned at a first end of the cylindrical post and a second opening positioned at a second, opposing end of the cylindrical post;
a flexible membrane positioned within the cylindrical post and adjacent to the window, the flexible membrane including a transparent portion;
a light transmissive cylindrical housing positioned at the first opening, the cylindrical housing including a top portion and a curved portion extending about the circumference of the cylindrical housing;
a shade positioned on the curved portion of the cylindrical housing; and
a light channel extending at least partially between the first and the second ends of the post, the light channel providing illumination through the window and the curved portion of the light transmissive cylindrical housing.

15. The illuminated display pillar of claim 14, wherein the light channel includes i) a light transmissive cylindrical post and ii) a light source positioned within the light transmissive cylindrical post.

16. The illuminated display pillar of claim 15, wherein the light source is a light-emitting diode (LED) strip positioned within the light transmissive cylindrical post.

17. The illuminated display pillar of claim 14, wherein the light channel is coupled to the upper portion of the post.

18. The illuminated display pillar of claim 17, further comprising a rod positioned through at least a part of the upper portion of the post and through the light channel to couple the light channel to the upper portion of the post.

19. The illuminated display pillar of claim 18, further comprising at least two flush bars positioned in an interior volume of the post and extending at least a portion of a length of the post and are adjacent to the window such that the flexible membrane is positioned between the flush bars and the post.

20. An illuminated display pillar, comprising:
a post, comprising:
i) a lower portion and an upper portion, the lower portion and the upper portion substantially opaque;
ii) a middle portion positioned between the lower and upper portions, the middle portion including a window extending around at least a portion of a circumference of the post;
iii) a first opening positioned at a first end of the post and a second opening positioned at a second, opposing end of the post;
a flexible membrane positioned within the post and adjacent to the window, the flexible membrane including a transparent portion;
flush bars extending between the first and the second ends of the post and coupled to the lower portion and the upper portions of the post, the flush bars positioned adjunct to the first opening such that the flexible membrane is positioned between the flush bars and the post;
a light transmissive cylindrical housing positioned at the first opening, the cylindrical housing including a top portion and a curved portion extending about a circumference of the cylindrical housing;
a shade positioned on the curved portion of the cylindrical housing; and
a light channel extending at least partially between the first and the second ends of the post and coupled to the upper portion of the post, the light channel including i) a light transmissive cylindrical post and ii) a light source positioned within the light transmissive cylindrical post, the light channel providing illumination through the window and the light transmissive cylindrical housing, wherein the shade separates the illumination through the top portion of the cylindrical housing from the illumination through the curved portion of the cylindrical housing.
